(19) United States
(12) Patent Application Publication
(10) Pub. No.: US 2011/0253587 A1
(43) Pub. Date: Oct. 20, 2011

(54) CARTON TRAY

(76) Inventor: Felicia A. Pinkstone, Aston, PA (US)

(21) Appl. No.: 13/101,390

(22) Filed: May 5, 2011

Related U.S. Application Data
(63) Continuation-in-part of application No. 12/779,365, filed on May 13, 2010.
(60) Provisional application No. 61/332,020, filed on May 6, 2010.
(60) Provisional application No. 61/216,191, filed on May 14, 2009.

(51) Int. Cl. B65D 5/20; B31B 1/26; B31B 3/00; B65D 5/484; B65D 5/64

(52) U.S. Cl. 206/557; 220/523; 220/524; 220/557; 229/120.08; 229/120.24; 493/90; 493/152; 493/162

(57) ABSTRACT

A carton comprising at least one tray section for holding a plurality of products. The at least one tray section can comprise a bottom panel, a first side panel foldably connected to the bottom panel, a second side panel foldably connected to the bottom panel, and at least one end panel foldably connected to the bottom panel. A first side end flap and a second side end flap can at least partially overlap the at least one end panel. The at least one end panel can comprise a first end panel edge and an opposing second end panel edge. The first side panel can be generally aligned with the first end panel edge along the length of the first end panel edge, and the second side panel can be generally aligned with the second end panel edge along the length of the second end panel edge.

### CROSS-REFERENCE TO RELATED APPLICATION

This application claims the benefit of U.S. Provisional Application No. 61/332,020, which was filed on May 6, 2010. This application is a Continuation-In-Part of U.S. patent application No. 12/779,365, which was filed on May 13, 2010, and claims the benefit of U.S. Provisional Application No. 61/216,191, which was filed on May 14, 2009.

### Incorporation by Reference

The disclosures of U.S. Provisional Application No. 61/332,020, which was filed on May 6, 2010, U.S. patent application No. 12/779,365, which was filed on May 13, 2010, and U.S. Provisional Application No. 61/216,191, which was filed on May 14, 2009, are hereby incorporated by reference for all purposes as if presented herein in their entirety.

### BACKGROUND

The present disclosure generally relates to cartons for holding and transporting articles. More specifically, the present disclosure relates to carton trays.

### SUMMARY

In one aspect, the disclosure is generally directed to a carton comprising at least one tray section for holding a plurality of products. The at least one tray section can comprise a plurality of panels at least partially extending around an interior of the at least one tray section. The plurality of panels can comprise a bottom panel, a first side panel foldably connected to the bottom panel, a second side panel foldably connected to the bottom panel, and at least one end panel foldably connected to the bottom panel. A first side end flap can be foldably connected to the first side panel along a longitudinal fold line, and a second side end flap can be foldably connected to the second side panel along the longitudinal fold line. Each of the first and second side end flaps can at least partially overlap the at least one end panel. The at least one end panel can comprise a first end panel edge and an opposing second end panel edge. The first side panel can comprise a first side panel edge that is generally aligned with the first end panel edge along the length of the first end panel edge, and the second side panel can comprise a second side panel edge that is generally aligned with the second end panel edge along the length of the second end panel edge.

In general, another aspect of the disclosure is directed to a blank comprising at least one tray portion for forming at least one tray section of a carton. The at least one tray portion can comprise a plurality of panels comprising a bottom panel, a first side panel foldably connected to the bottom panel, a second side panel foldably connected to the bottom panel, and at least one end panel foldably connected to the bottom panel. A first side end flap can be foldably connected to the first side panel along a longitudinal fold line, and a second side end flap can be foldably connected to the second side panel along the longitudinal fold line. Each of the first and second side end flaps are for at least partially overlapping the at least one end panel. The at least one end panel can comprise a first end panel edge and an opposing second end panel edge. The first side panel can comprise a first side panel edge for being generally aligned with the first end panel edge along the length of the first end panel edge in the carton formed from the blank, and the second side panel can comprise a second side panel edge for being generally aligned with the second end panel edge along the length of the second end panel edge in the carton formed from the blank.

In general, another aspect of the disclosure is directed to a method of forming a carton comprising at least one tray section. The method can comprise obtaining a blank comprising at least one tray portion. The at least one tray portion can comprise a plurality of panels comprising a bottom panel, a first side panel foldably connected to the bottom panel, a second side panel foldably connected to the bottom panel, and at least one end panel foldably connected to the bottom panel. A first side end flap can be foldably connected to the first side panel along a longitudinal fold line, and a second side end flap can be foldably connected to the second side panel along the longitudinal fold line. The method can further comprise forming the at least one tray section having an interior from the at least one tray portion by folding the at least one end panel relative to the bottom panel and folding the first and second side panels relative to the bottom panel so that at least a portion of each of the first and second side panels is generally aligned with a respective first end panel edge and second end panel edge of the at least one end panel. The method can further comprise overlapping at least a portion of each of the first and second side end flaps with at least a portion of the at least one end panel.

The present disclosure generally relates to blanks, packages, or cartons for holding and/or dispensing products, such as food items, cans, rolls, bottles, and various other articles including pre-packaged items.

In one aspect, the present invention includes a blank that includes a first ledge portion foldably connected along a first fold line to a first side panel, which in turn is foldably connected along a second fold line to a bottom panel, which in turn is foldably connected along a third fold line to a second side panel, and the second side panel foldably connected along a fourth fold line to a second ledge portion. A first end flap is connected to the first side panel at a first end of the blank, a second end flap is connected at the first end of the bottom panel, and a third end flap is connected to the second side panel at the first end of the blank. A fourth end flap is connected to the first side panel at a second end of the blank, a fifth end flap is connected at the second end of the bottom panel, and a sixth end flap is connected to the second side panel at the second end of the blank. A third ledge portion is connected to the second end flap and a fourth ledge portion is connected to the fifth end flap.

Optionally, the first end flap can cover less than the entirety of a periphery of the first side panel at the first end, with a seventh end flap connected to the first side panel at the first end. Optionally, the third end flap can cover less than the entirety of a periphery of the second side panel at the first end, and, an eighth end flap can be connected to the second side panel at the first end. Optionally, the fourth end flap can cover less than the entirety of a periphery of the first side panel at the second end, and, a ninth end flap can be connected to the first side panel at the second end. Optionally, the sixth end flap can cover less than the entirety of a periphery of the second side panel at the second end, with a tenth end flap connected to the second side panel at the second end. Generally, the second end flap, the fifth end flap, and the bottom panel are arranged in a substantially hourglass shape. Also, generally, the first ledge portion, the second ledge portion, the third ledge portion, and the fourth ledge portion are foldable to form a substantially continuous lip or circumferentially extending ledge around a periphery of a carton formed from the blank.

In another aspect, the invention includes a package that comprises at least one article and a carton receiving the at least one article. The carton is formed from a blank that includes a first ledge portion foldably connected along a first fold line to a first side panel, which in turn is foldably connected along a second fold line to a bottom panel, which in turn is foldably connected along a third fold line to a second side panel, and the second side panel foldably connected along a fourth fold line to a second ledge portion. A first end flap is connected to the first side panel at a first end of the blank, a second end flap is connected at the first end of the bottom panel, and a third end flap is connected to the second side panel at the first end of the blank. A fourth end flap is connected to the first side panel at a second end of the blank, a fifth end flap is connected at the second end of the bottom panel, and a sixth end flap is connected to the second side panel at the second end of the blank. A third ledge portion is connected to the second end flap and a fourth ledge portion is connected to the fifth end flap.

Optionally, the first end flap can cover less than the entirety of a periphery of the first side panel at the first end, with a seventh end flap connected to the first side panel at the first end. Optionally, the third end flap can cover less than the entirety of a periphery of the second side panel at the first end, and, an eighth end flap can be connected to the second side panel at the first end. Optionally, the fourth end flap can cover less than the entirety of a periphery of the first side panel at the second end, and, a ninth end flap can be connected to the first side panel at the second end. Optionally, the sixth end flap can cover less than the entirety of a periphery of the second side panel at the second end, with a tenth end flap connected to the second side panel at the second end. Generally, the second end flap, the fifth end flap, and the bottom panel are arranged in a substantially hourglass shape. Also, generally, the first ledge portion, the second ledge portion, the third ledge portion, and the fourth ledge portion are foldable to form a substantially continuous lip or circumferentially extending ledge around a periphery of a carton formed from the blank.

In another embodiment, the invention includes a carton including a first compartment connected to a second compartment along a first fold line. The first compartment and the second compartment are capable of being covered by a lid. The lid is capable of being hinged between and open position and a closed position, with the first compartment and the second compartment being accessible when the lid is in the open position. The lid can include a tear strip that is removable from the carton to allow the lid to move from the closed position to the open position.

In another embodiment, the invention includes a package including at least one article and a carton, the carton including a first compartment connected to a second compartment along a first fold line. The first compartment and the second compartment are capable of being covered by a lid, and the lid is capable of being hinged between and open position and a closed position, with the first compartment and the second compartment being accessible when the lid is in the open position. The lid can include a tear strip that is removable from the carton to allow the lid to move from the closed position to the open position.

Those skilled in the art will appreciate the above stated advantages and other advantages and benefits of various additional embodiments upon reading the following detailed description of the exemplary embodiments with reference to the below listed drawing figures.

According to common practice, the various features of the drawings discussed below are not necessarily drawn to scale. Dimensions of various features and elements in the drawings may be expanded or reduced to illustrate more clearly the embodiments of the disclosure.

### BRIEF DESCRIPTION OF THE DRAWINGS

FIG. 1 is a plan view of a carton blank according to a first embodiment.

FIG. 2 shows a perspective view of a carton formed from the blank of FIG. 1.

FIG. 3 shows a plan view of a carton blank according to a second embodiment.

FIG. 4 shows a perspective view of a carton formed from the blank of FIG. 3.

FIG. 5 shows a plan view of a carton blank according to a third embodiment.

FIG. 6A shows a perspective view of a carton formed from the blank of FIG. 5.

FIG. 6B shows a perspective view of the carton of FIG. 6A with the lid opened.

FIG. 7 shows a plan view of a carton blank according to a fourth embodiment.

FIG. 8A shows a bottom view of a carton formed from the blank of FIG. 7.

FIG. 8B shows a top view of the carton of FIG. 8A.

FIG. 9 is an exterior plan view of a blank for forming a carton according to a fifth embodiment of the disclosure.

FIG. 10 is a perspective view of the assembled carton according to the fifth embodiment.

FIG. 11 is an exterior plan view of a blank for forming a carton according to a sixth embodiment of the disclosure.

FIG. 12 is a perspective view of the assembled carton according to the sixth embodiment.

FIG. 13 is an exterior plan view of a blank for forming a carton according to a seventh embodiment of the disclosure.

FIG. 14 is a perspective view of the assembled carton according to the seventh embodiment.

FIG. 15 is an exterior plan view of a blank for forming a carton according to a eighth embodiment of the disclosure.

FIG. 16 is a perspective view of the assembled carton according to the eighth embodiment.

FIG. 17 is an exterior plan view of a blank for forming a carton according to a ninth embodiment of the disclosure.

FIG. 18 is a perspective view of the assembled carton according to the ninth embodiment.

Corresponding parts are designated by corresponding reference figures throughout the drawings.

### DETAILED DESCRIPTION OF THE EXEMPLARY EMBODIMENTS

This disclosure generally relates to cartons suitable for storing and dispensing contents or articles, methods of erecting such cartons from a carton blank, methods of dispensing from the formed carton, and a carton for and methods for slanting or tilting product within the carton toward a rear portion of the carton. For purposes of illustration and not limitation, the detailed description below describes several embodiments of the invention within the context of a carton with an opener for dispensing contents or articles from the carton. Further, references herein to “end,” “side,” “front,” “rear,” “bottom,” and “top” generally refer to orientations and positions of elements when the carton is erected and/or disposed in an upright orientation. The terms “upper,” “lower,” “vertical,” “horizontal,” and “oblique,” and any variations thereof, generally refer to the location and/or orientation of an element or line with respect to a drawing figure in which it appears. Reference characters shared among the various embodiments disclosed herein include similar parts.

The present invention relates to a tray, carton, or package for items. The present embodiments are intended to replace, for example, thermoform/plastic trays, such as those that hold a variety of common products (such as, cookies, crackers, lunch meats, bread products, etc.), with sustainable trays and tray packages that utilize paperboard. Generally, the present embodiments provide, cradle hammock shaped or otherwise similarly shaped compartments, which, among other benefits, provide strength for shipping and product protection. The present embodiments provide compartmental, somewhat curved paperboard tray(s), which could be formed in any desired shape, size, or orientation to accommodate any number of items. Generally, the present tray(s)/carton(s) are filled with items, such as cookies, crackers, lunch meats, bread products, etc. for example, to form a package. Generally, the items are contained in the package for shipping to a point-of-sale vendor (e.g., grocery store). Optionally, the point-of-sale vendor can convert the package to a display unit for displaying items to consumers.

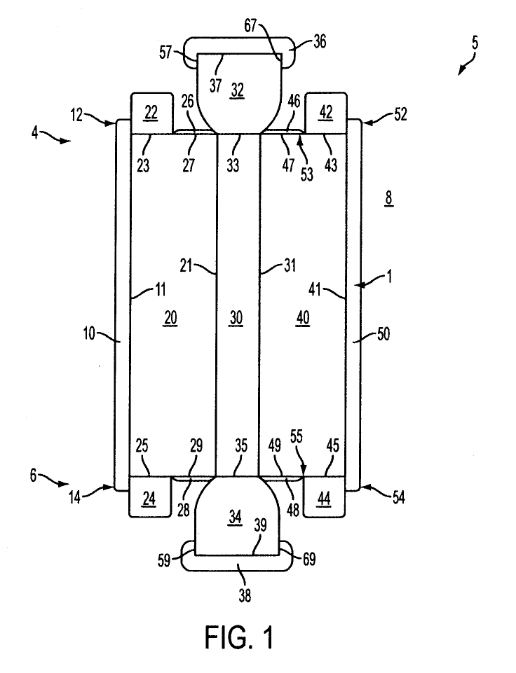

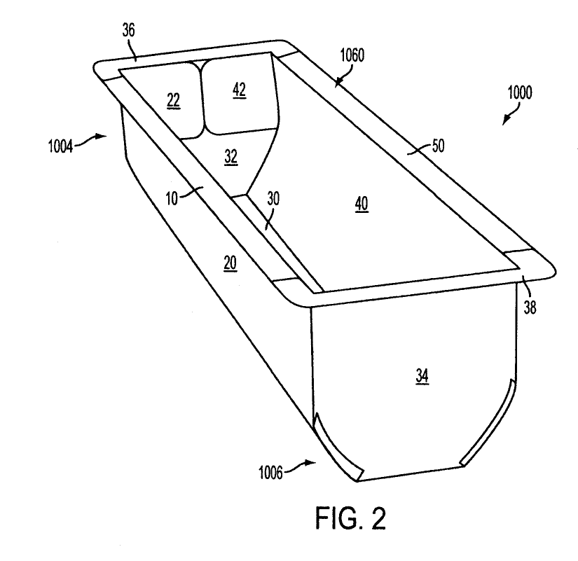

FIG. 1 illustrates an outer facing surface 1 of a carton blank 5 from which a carton 1000 (FIG. 2) can be erected. The blank 5 (FIG. 1) includes a first end 4, second end 6, and a first panel 10, a second panel 20, a third panel 30, a fourth panel 40, and a fifth panel 50. Panel 10 is foldably connected along fold line 11 to panel 20, panel 20 is foldably connected along fold line 21 to panel 30, panel 30 is foldably connected along fold line 31 to panel 40, and panel 40 is foldably connected along fold line 41 to panel 50. Panel 10 and panel 50 include ledge extensions that extend toward a periphery 8 of the blank 5 at lengths greater than the lengths of panels 20, 30, and 40. Panel 10 includes ledge portion 12 at first end 4 and ledge portion 14 at second end 6. Panel 50 similarly includes ledge portion 52 at first end 4 and ledge portion 54 at second end 6.

Blank 5 includes end flaps, including end flaps 22, 26, 32, 42, and 46, at the first end 4 and 24, 28, 34, 44, and 48 at the second end 6. End flap 22 is foldably connected along a fold line 23 at the first end 4 of panel 20. End flap 24 is foldably connected along a fold line 25 at the second end 6 of panel 20. End flap 26 is foldably connected along fold line 27 at the first end 4 of panel 20. End flap 28 is foldably connected along fold line 29 at the second end 6 of panel 20. End flap 32 is foldably connected along fold line 33 at the first end 4 of panel 30. End flap 34 is foldably connected along fold line 35 at second end 6 to panel 30. End flap 46 is foldably connected along fold line 47 at the first end 4 of panel 40. End flap 42 is foldably connected along fold line 43 to panel 40. End flap 48 is foldably connected along fold line 49 at the second end 6 of panel 40. End flap 44 is foldably connected along fold line 45 at the second end 6 of panel 40. A first end ledge panel 36 is connected to end flap 32 along fold lines 37, 57, and 67, while a second end ledge panel 38 is connected to end flap 34 along fold lines 39, 59, and 69.

As shown in FIG. 1, fold lines 23, 25, 27, 29, 33, 35, 43, 45, 47, and 49 generally extend transverse to fold lines 11, 21, 31, and 41. One or more of fold lines 23, 27, 33, 43, 47 also could be replaced by a single fold line, such as indicated at 53, while one or more of fold lines 25, 29, 35, 45, 49 could be replaced by a single fold line, such as indicated at 55. End flaps 22, 24, 26, 28, 32, 34, 42, 44, 46, and 48 generally extend in a direction away from respective fold lines 23, 25, 27, 29, 33, 35, 43, 45, 47, and 49 toward the periphery 8 of the blank 5. Further, in view of “panels,” the surfaces of carton 1000 (FIG. 2) formed from the blank 5 can be referred to as “walls” or “sides.” Further still, the panels 20, 30, 40 can be referred to as the surfaces they form when constructed in the form of a carton, such as the carton shown in FIG. 2. For example, panel 30 can be referenced as bottom panel, panel 20 can be referenced as a first side panel, and panel 40 can be referenced as a second side panel. Additionally, end flaps 22, 26, 32, 42, 46 (FIG. 1) can be closed to form a first carton end, and end flaps 24, 28, 34, 44, 48 can be closed to form a second carton end as indicated in FIG. 2.

FIG. 2 shows a perspective view of a carton 1000 formed from the blank of FIG. 1. The blank 5 may be folded from the configuration shown in FIG. 1 to the configuration shown in FIG. 2 by folding the blank along fold lines 11, 21, 31, and 41. During a folding sequence, the end flaps are folded toward the interior, with either the end flaps at the first end 4 or the end flaps at the second end 6 folded inward first. At the first end 4, end flaps 22, 26, 42, and 46 can be folded inwardly along fold lines 23, 27, 43, and 47, respectively, so as to extend substantially perpendicular to panel 30. Next, end flap 32 is folded inwardly along fold line 33 so as to extend substantially perpendicular to panel 30. At end 6, end flaps 24, 28, 44, and 48 are folded inwardly along fold lines 25, 29, 45, and 49, respectively, so as to extend substantially perpendicular to panel 30. Next, end flap 34 is folded inwardly along fold line 35 so as to extend substantially perpendicular to panel 30. Generally, end flaps 22, 26, 32, 42, and 46 are adhered, such as by an adhesive such as glue, to form a first end 1004 (FIG. 2) of carton 1000, and end flaps 24, 28, 34, 44, and 48 (FIG. 1) are adhered, such as by an adhesive such as glue, to form a second end 1006 (FIG. 2) of carton 1000.

To form the circumferential ledge or lip 1060 that extends along and around an upper portion of the carton 1000 as shown in FIG. 2, once the end flaps are folded inwardly, panel 10 and panel 50 can be folded outwardly along respective fold lines 11 and 41, and ledges portions 36 and 38 are folded along respective fold lines 37, 57, 67 and 39, 59, 69. In this manner, the ledges portions 36 and 38 and panels 10 and 50 generally are adhered, such as by an adhesive such as glue, to form a substantially continuous ledge or lip 1060 surrounding the upper periphery of the carton 1000 of FIG. 2.

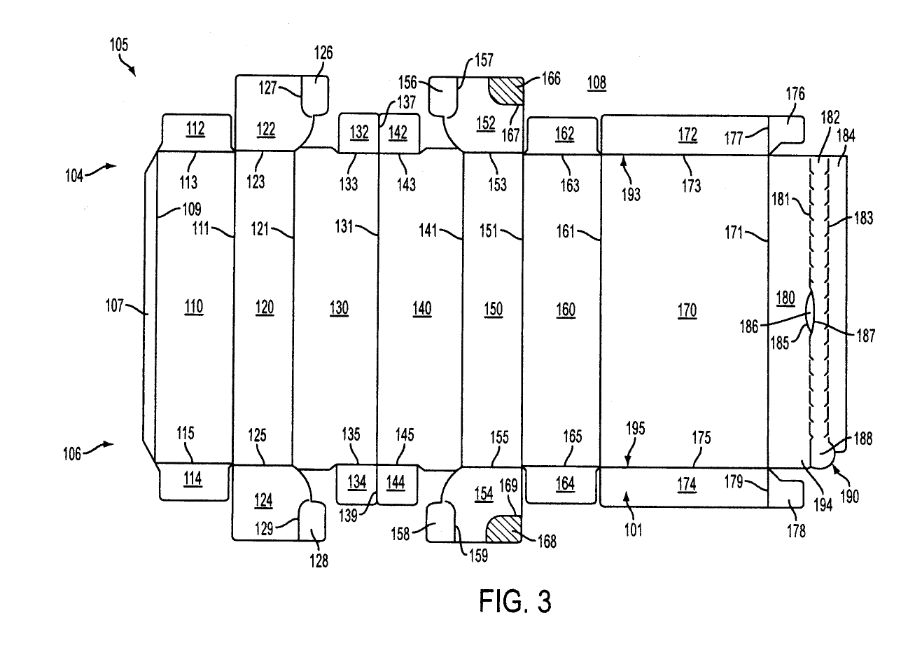

FIG. 3 shows a plan view of a carton blank according to a second embodiment, illustrating an outer facing surface 101 of a carton blank 105 from which a carton 1100 (FIG. 3) can be erected. The blank 105 includes first and second sides 104/106, an adhesive panel 107, a first panel 110, a second panel 120, a third panel 130, a fourth panel 140, a fifth panel 150, a sixth panel 160, a seventh panel 170, and an eighth panel 180. Panel 180 is separated by a tear strip 190 into first panel portion 184 and second panel portion 194. The tear strip 190 includes a tear strip panel 182 defined between tear lines 181 and 183, includes a tear strip starting flap 188 (which is shown with a bulbous shape to allow ease of gripping of the tear strip 190), and includes an opening feature, finger flap, or opening 186 defined along tear line 181 between lines of disruption 185 and 187.

Adhesive flap 107 is foldably connected along fold line 109 to panel 110, panel 110 is foldably connected along fold line 111 to panel 120, panel 120 is foldably connected along fold line 121 to panel 130, panel 130 is foldably connected along fold line 131 to panel 140, panel 140 is foldably connected along fold line 141 to panel 150, panel 150 is foldably connected along fold line 151 to panel 160, panel 160 is foldably connected along fold line 161 to panel 170, and panel 170 is foldably connected along fold line 171 to panel 180.

Blank 105 includes end flaps disposed along a first end 104 and along the second side 106 of the blank. End flap 112 is connected along a fold line 113 along the first side 104 of the blank to panel 110, and end flap 114 is foldably connected along a fold line 115 along the second side 106 of the blank to panel 110. End flap 122 is foldably connected along a fold line 123 to panel 120, while end flap portion 126 is connected to end flap 122 along fold line 127. End flap 124 is foldably connected along a fold line 125 along the second side 106 of the blank to panel 120. An end flap portion 128 is connected to end flap 124 along fold line 129. End flap 132 is foldably connected along a fold line 133 along the first side 104 of the blank to panel 130. End flap 134 is foldably connected along fold line 135 along the second side 106 of the blank to panel 130.

End flap 142 is foldably connected along fold line 143 to panel 140. End flaps 132 and 142 are connected along fold line 137. End flap 144 is foldably connected along fold line 145 along the second side 106 of the blank to panel 140, and end flaps 134 and 144 are connected along fold line 139. End flap 152 is foldably connected along a fold line 153 to panel 150. An end flap portion 156 is connected to end flap 152 along fold line 157. End flap 152 also is shown in FIG. 3 with a glue locator 166 defined by a line 167. End flap 154 is foldably connected along a fold line 155 along the second side 106 of the blank to panel 150. An end flap portion 158 is connected to end flap 154 along fold line 159. End flap 154 also is shown in FIG. 3 with a glue locator 168 defined by a line 169. End flap 162 is foldably connected along a fold line 163 along the first side 104 of the blank to panel 160. End flap 164 is foldably connected along fold line 165 along second side 106 to the blank to panel 160. End flap 172 is foldably connected along fold line 173 to panel 170. An end flap portion 176 is foldably connected along fold line 177 to end flap 172. End flap 174 is foldably connected along fold line 175 along the second side 106 of the blank to panel 170. An end flap portion 178 is foldably connected along fold line 179 to end flap 174.

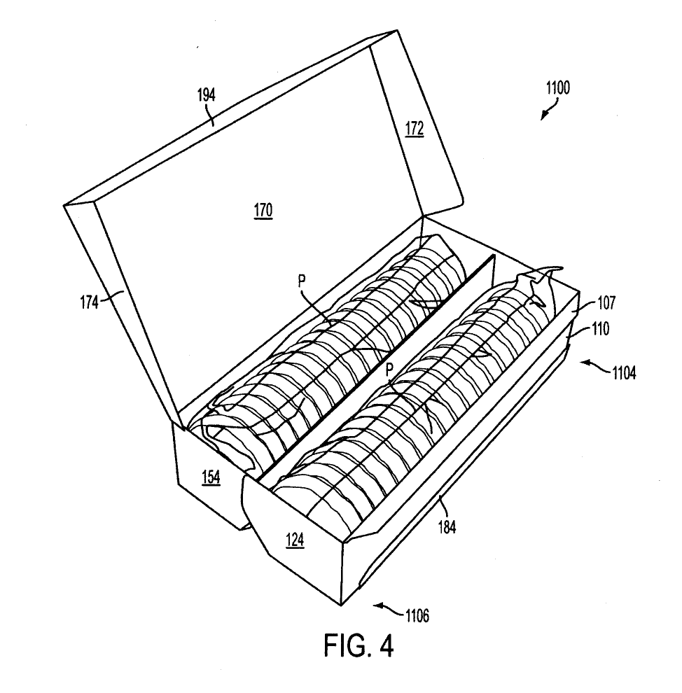

Fold lines 113, 115, 123, 125, 133, 135, 143, 145, 153, 155, 163, 165, 173, and 175 are generally transverse to fold lines 109, 111, 121, 131, 141, 151, 161, and 171. One or more of fold lines 113, 123, 133, 143, 153, 163, 173 could be replaced by a single fold line, such as indicated at 193. One or more of fold lines 115, 125, 135, 145, 155, 165, 175 could be replaced by a single fold line, such as indicated at 195. End flaps 112, 114, 122, 124, 132, 134, 142, 144, 152, 154, 162, 164, 172, and 174 generally extend in a direction away from respective fold lines 113, 115, 123, 125, 133, 135, 143, 145, 153, 155, 163, 165, 173, 175 toward periphery 108 of blank 105. Further, the panels forming the surfaces of a carton 1100 (FIG. 4) formed from the blank 105 can be referred to as “walls” or “sides.” Further still, the panels 110, 120, 130, 140, 150, 160, 170, 180 can be referred to as the surfaces they forms when constructed in the form of a carton, such as the carton shown in FIG. 4. For example, panel 110 can be referenced as first side panel, panel 120 can be referenced as first bottom panel, panel 130 can be referenced as second side panel, panel 140 can be referenced as third side panel, panel 150 can be referenced as second bottom panel, panel 160 can be referenced as fourth side panel, panel 170 can be referenced as lid panel, and panel 180 can be referenced as lip panel. Additionally, end flaps 112, 122, 132, 142, 152, 162, 172 (FIG. 3) can be closed to form a first carton end 1104 (FIG. 4), and end flaps 114, 124, 134, 144, 154, 164, 174 (FIG. 3) can be closed to form a second carton end 1106 (FIG. 4).

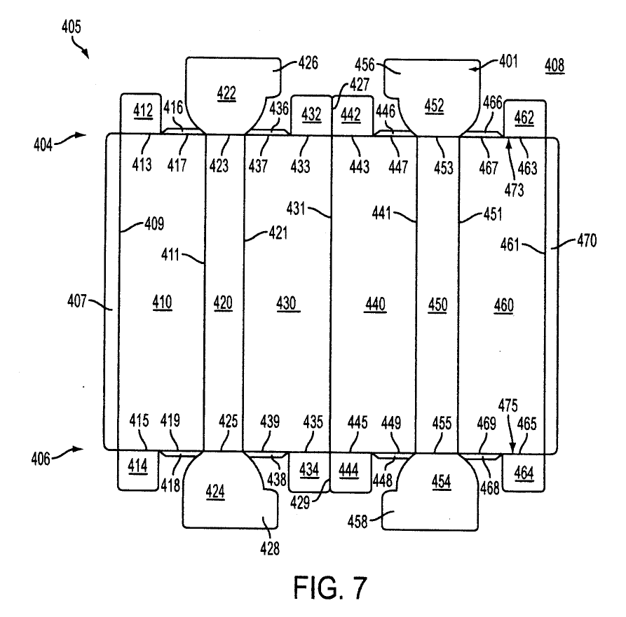

FIG. 4 shows a perspective view of a carton 1100 formed from the blank of FIG. 3. The blank 105 may be folded from the configuration shown in FIG. 3 to the configuration shown in FIG. 4 by folding the blank along fold lines 111, 121, 131, 141, 151, 161, and 171. During a folding sequence, the end flaps are folded toward the interior, with either the end flaps along the first side 104 or the end flaps along the second side 106 folded inwardly first. End flaps 112, 122, 132, 142, 152, 162, and 172 are folded inwardly along fold lines 113, 123, 133, 143, 153, 163, and 173, respectively, so as to extend substantially perpendicular to panel 120. Next, end flaps 122 and 152 are folded inwardly along respective fold lines 123 and 153 so as to extend substantially perpendicular to panel 120. Along side 106, end flaps 114, 124, 134, 144, 154, 164, and 174 are folded inwardly along fold lines 115, 125, 135, 145, 155, 165, and 175, respectively, so as to extend substantially perpendicular to panel 120, after which end flaps 124 and 154 are folded inwardly along respective fold lines 125 and 155 so as to extend substantially perpendicular to panel 120. Generally, end flaps 112, 122, 132, 142, 152, 162, 172 are adhered, such as by an adhesive such as glue, to form a first end 1104 of carton 1100, and end flaps 114, 124, 134, 144, 154, 164, 174 are adhered, such as by an adhesive such as glue, to form a second end 1106 of carton 1100. As shown in FIG. 7, the lip panel 194 of panel 180 can be hinged upwardly to dispose the lid portion in an open configuration. First, the tear panel 182 of tear strip 190 is detached along tear lines 181 and 183 and the panel 170 is hinged upward along fold line 161 to expose product P in the interior of the carton 1100. Products P then can be dispensed from the carton 1100.

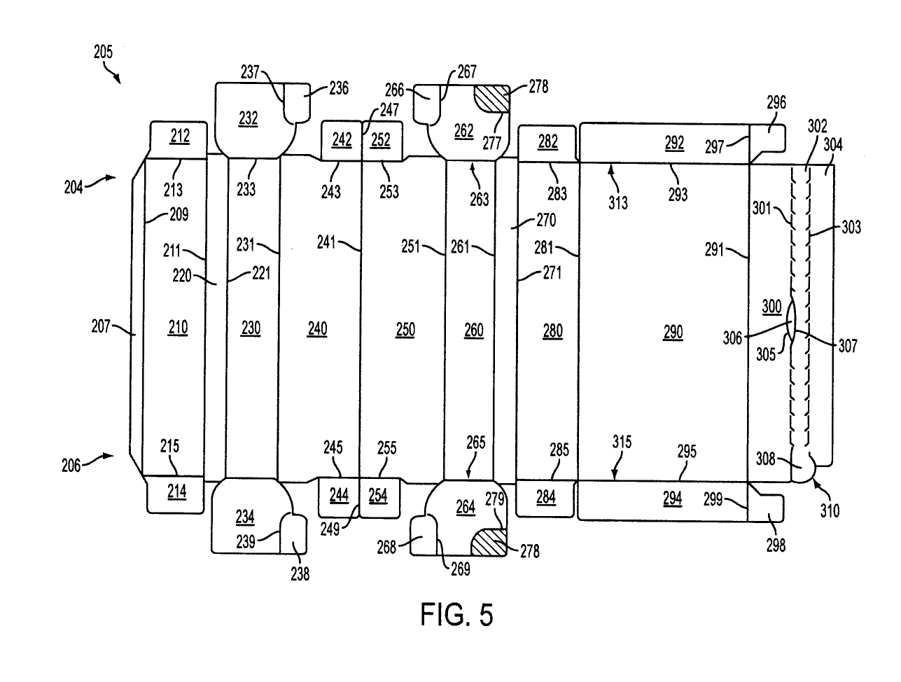

FIG. 5 shows a plan view of a carton blank according to a third embodiment. The blank 205 of FIG. 5 is similar to the blank 105 of FIG. 3. One difference between blanks 105 and 205 is the inclusion of two additional panels (220 and 270) that allow the compartments of the carton 1200 formed from blank 205 to have a more hexagonal shape as desired than the carton 1100 formed from blank 105. This hexagonal design will more easily allow the carton 1200 formed from the blank 205 to be disposed in a desired orientation, such as on a side to allow stacking or alignment on a display shelf, for example. Another difference between blank 105 and blank 205 is the shape of the end flaps 232, 234, 262, and 264, which can have more of an hourglass or rounded shape in blank 205 to compensate for the additional panels 220 and 270. Other similarities and differences can be discovered by detailed comparison of blanks 105 and 205.

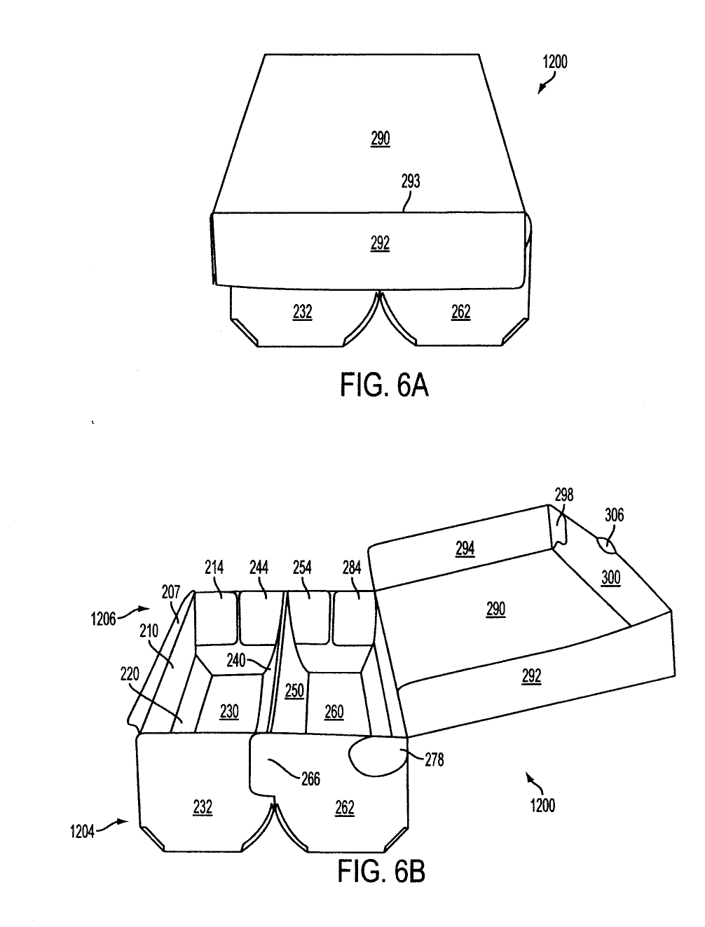

FIG. 6A shows a carton formed from the blank of FIG. 5. FIG. 6B shows the carton of FIG. 6A with the lid opened. The carton 1200 of FIGS. 6A and 6B are similar to the carton 1100 shown in FIG. 4. Other similarities and differences can be discovered by detailed comparison of cartons 1100 and 1200.

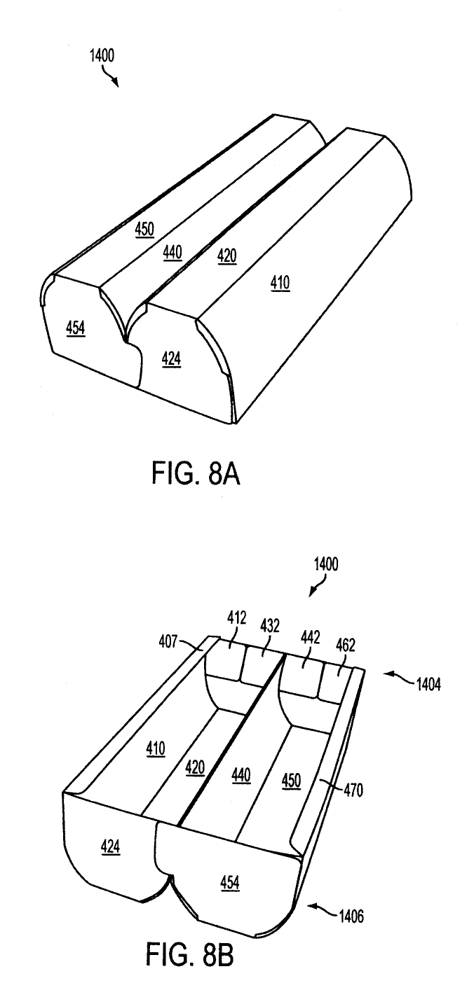

FIG. 7 shows a plan view of a carton blank 405 according to a fourth embodiment. FIG. 7 illustrates an outer facing surface 401 of the carton blank 405 from which a carton 1400 (FIGS. 8A and 8B) can be erected. The blank 405 includes a first side 404, a second side 406, a first ledge panel 407, a first panel 410, a second panel 420, a third panel 430, a fourth panel 440, a fifth panel 450, a sixth panel 460, and a second ledge panel 470. Panel 407 is foldably connected along fold line 409 to panel 410, panel 410 is foldably connected along fold line 411 to panel 420, panel 420 is foldably connected along fold line 421 to panel 430, panel 430 is foldably connected along fold line 431 to panel 440, panel 440 is foldably connected along fold line 441 to panel 450, panel 450 is foldably connected along fold line 451 to panel 460, panel 460 is foldably connected along fold line 461 to panel 470.

Blank 405 further includes end flaps, including end flaps 412, 414, 416, 418, 422, 424, 432, 434, 436, 438, 442, 444, 446, 448, 452, 454, 462, 464, 466, 468. End flap 412 is foldably connected along a fold line 413 along the first side 404 of the carton, and end flap 416 is foldably connected along a fold line 417 to panel 410. Similarly, end flap 414 is foldably connected to panel 410 along a fold line 415 along the second side 406 of the blank, while end flap 418 is foldably connected along a fold line 419 to panel 410. End flap 422 is foldably connected along a fold line 423 to panel 420, and end flap 424 is foldably connected to panel 420 along a fold line 425 along the second side 406 of the blank 405. End flap 432 is foldably connected along fold line 433 along the first side 404 of the blank 405 to panel 430, with end flap 436 foldably connected along fold line 437 to panel 430. End flap 434 is foldably connected along fold line 435 at the second side 406 of panel 430, and end flap 438 is foldably connected along fold line 439 along the second side 406 of the blank to panel 430. End flap 442 is foldably connected along fold line 443 along the first side 404 of the blank to panel 440, with end flap 446 foldably connected along fold line 447 to panel 440. Additionally, end flaps 444 and 448 are foldably connected to panel 440 along fold lines 445 and 449 along the second side 406 of the blank. End flaps 432 and 442 are connected along a fold line 427, and end flaps 434 and 444 are connected along a fold line 429. End flap 452 is foldably connected to panel 450 along a fold line 453 extending along the first side 404 of the blank, and end flap 454 is foldably connected along a fold line 455 extending along the second side 406 of the blank to panel 450. End flaps 462 and 466 are foldably connected to panel 460 along fold lines 463 and 467 and extending along the first side 404 of the blank. End flaps and 466 are foldably connected to panel 460 along fold lines 465 and 469 along the second side 406 of the blank. End flap 422 includes an extended flap portion 426, end flap 424 includes an extended flap portion 428, end flap 452 includes an extended flap portion 456, and end flap 454 includes an extended flap portion 458.

Fold lines 413, 415, 417, 419, 423, 425, 433, 435, 437, 439, 443, 445, 447, 449, 453, 455, 463, 465, 467, 469 are generally transverse to fold lines 409, 411, 421, 431, 441, 451, and 461. One or more of fold lines 413, 417, 423, 433, 437, 443, 447, 453, 463, 467 could be replaced by a single fold line, such as indicated at 473. One or more of fold lines 415, 419, 425, 435, 439, 445, 449, 454, 465, 469 could be replaced by a single fold line, such as indicated at 475. End flaps 412, 414, 416, 418, 422, 424, 432, 434, 436, 438, 442, 444, 446, 448, 452, 454, 462, 464, 466, 468 generally extend in a direction away from respective fold lines 413, 415, 417, 419, 423, 425, 433, 435, 437, 439, 443, 445, 447, 449, 453, 455, 463, 465, 467, 469 toward periphery 408 of blank 405. Further, the panels defining the surfaces of carton 1400 formed from the blank 405 also can be referred to as “walls” or “sides.” Further still, the panels 410, 420, 430, 440, 450, 460 can be referred to as the surfaces they forms when constructed in the form of a carton, such as the carton shown in FIGS. 8A and 8B. For example, panel 420 can be referenced as first bottom panel, panel 410 can be referenced as first side panel, panel 430 can be referenced as second side panel, panel 440 can be referenced as third side panel, panel 450 can be referenced as second bottom panel, and panel 460 can be referenced as fourth side panel. Additionally, end flaps 412, 416, 422, 432, 436, 442, 446, 452, 462, and 466 can be closed to form a first carton end 1404, and end flaps 414, 418, 424, 434, 438, 444, 448, 454, 464, and 468 can be closed to form a second carton end 1406.

FIG. 8A shows a bottom view of a carton formed from the blank of FIG. 7. FIG. 8B shows a top view of the carton of FIG. 8A. The blank 405 may be folded from the configuration shown in FIG. 7 to the configurations shown in FIGS. 8A and 8B by folding the blank 405 along fold lines 409, 411, 421, 431, 441, 451, and 461. During a folding sequence, the end flaps are folded toward the interior, with either the end flaps at the first end 404 or the end flaps at the second end 406 folded inward first. At end 404, end flaps 412, 416, 422, 432, 436, 442, 446, 452, 462, 466 are folded inwardly along fold lines 413, 417, 423, 433, 437, 443, 447, 453, 463, 467, respectively, so as to extend substantially perpendicular to panel 420. Next, end flaps 422 and 454 are folded inwardly along respective fold lines 423 and 453 so as to extend substantially perpendicular to panel 420. At end 406, end flaps 414, 418, 424, 434, 438, 444, 448, 454, 464, 468 are folded inwardly along fold lines 415, 419, 425, 435, 439, 445, 449, 454, 465, 469, respectively, so as to extend substantially perpendicular to panel 420. Next, end flaps 424 and 454 are folded inwardly along respective fold lines 425 and 455 so as to extend substantially perpendicular to panel 420. Generally, end flaps 412, 416, 422, 432, 436, 442, 446, 452, 462, and 466 are adhered, such as by an adhesive such as glue, to form a first end 1404 of carton 1400, and end flaps 414, 418, 424, 434, 438, 444, 448, 454, 464, and 468 are adhered, such as by an adhesive such as glue, to form a second end 1406 of carton 1400.

Panels 407 and 470 are folded inwardly to form a ledge or lip over each compartment that extends inwardly along and around an upper portion of the carton 1400 as shown in FIG. 8B.

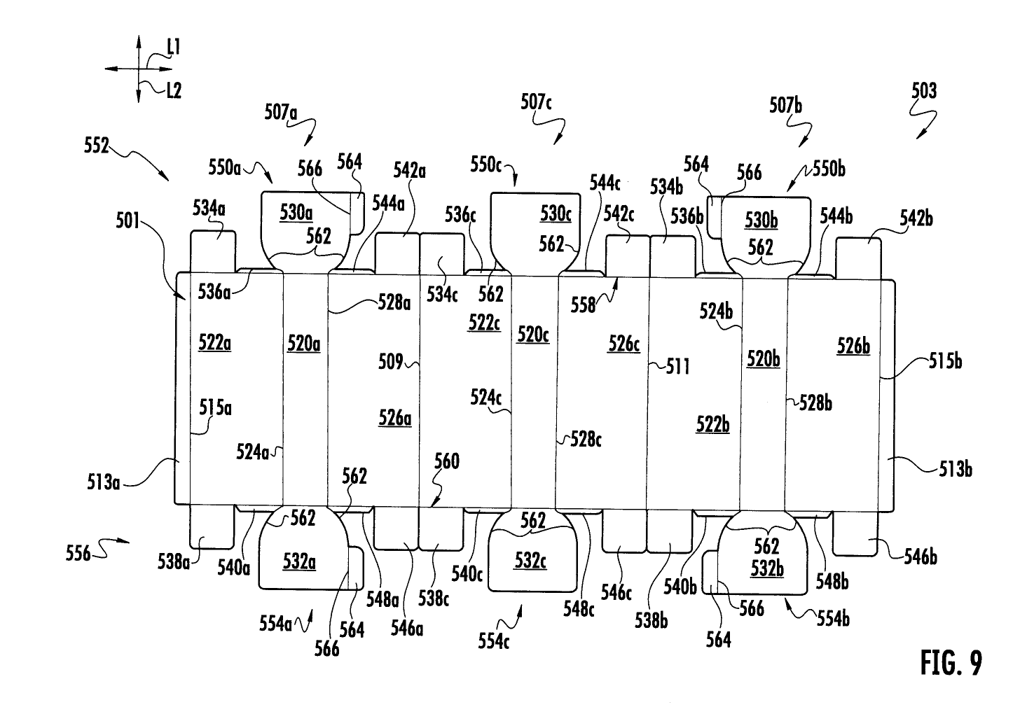

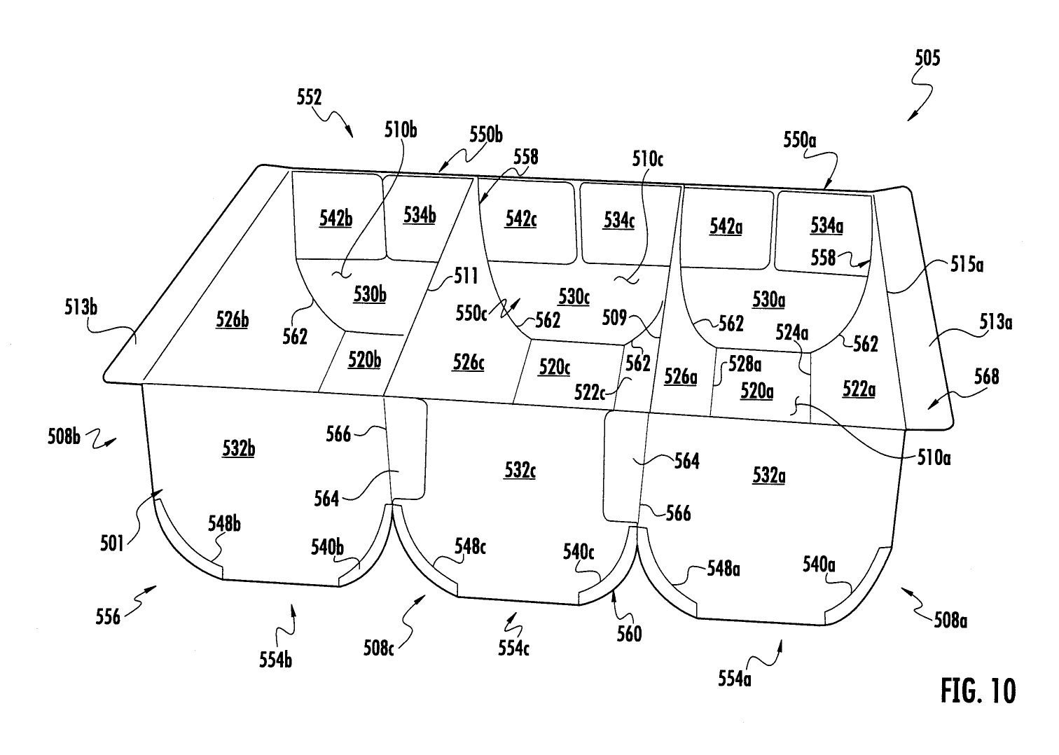

FIG. 9 is a plan view of an exterior surface 501 of a blank 503 for forming a carton 505 (FIG. 10) according to a fifth embodiment of the disclosure. The fifth embodiment is generally similar to the fourth embodiment, except for variations noted and variations that will be apparent to one of ordinary skill in the art. As shown in FIG. 9, the blank 503 includes a first tray portion 507a, a second tray portion 507b, and a third tray portion 507c foldably connected to the first tray portion 507a along a first transverse interconnecting fold line 509 and foldably connected to the second tray portion 507b along a second transverse interconnecting fold line 511. As shown in FIG. 10, the first, second, and third tray portions 507a, 507b, and 507c respectively form a first tray section 508a with a tray interior 510a, a second tray section 508b with a tray interior 510b, and a third tray section 508c with a tray interior 510c in the carton 505. A first ledge flap 513a is foldably connected to the first tray portion 507a along a third transverse fold line 515a, and a second ledge flap 513b is foldably connected to the second tray portion 507b along a fourth transverse fold line 515b.

The blank 503 has a longitudinal axis L1 and a transverse or lateral axis L2. In the illustrated embodiment, the first tray portion 507a includes a bottom panel 520a foldably connected to a first side panel 522a along a transverse fold line 524a and foldably connected to a second side panel 526a along a transverse fold line 528a. Similarly, the second and third tray portions 507b, 507c can include respective bottom panels 520b, 520c foldably connected to respective first side panels 522b, 522c along respective transverse fold lines 524b, 524c and foldably connected to respective second side panels 526b, 526c along respective transverse fold lines 528b, 528c.

Each of the bottom panels 520a, 520b, 520c is foldably connected to a respective first end panel 530a, 530b, 530c and a respective second end panel 532a, 532b, 532c. Each of the first side panels 522a, 522b, 522c is foldably connected to a respective first side end flap 534a, 534b, 534c, a first side tab 536a, 536b, 536c, a second side end flap 538a, 538b, 538c, and a second side end tab 540a, 540b, 540c. Each of the second side panels 526a, 526b, 526c is foldably connected to a respective first side end flap 542a, 542b, 542c, a first side tab 544a, 544b, 544c, a second side end flap 546a, 546b, 546c, and a second side end tab 548a, 548b, 548c. When the carton 505 is erected, the first end panel 530a, the first side end flaps 534a, 542a, and the first side tabs 536a, 544a close a first end 550a of the first tray section 508a at a first end 552 of the carton 505, and the second end panel 532a, the second side end flaps 538a, 546a, and the second side tabs 540a, 548a close a second end 554a of the first tray section 508a at a second end 556 of the carton 505. Similarly, the first end panel 530b, the first side end flaps 534b, 542b, and the first side tabs 536b, 544b close a first end 550b of the second tray section 508b at the first end 552 of the carton 505, and the second end panel 532b, the second side end flaps 538b, 546b, and the second side tabs 540b, 548b close a second end 554b of the second tray section 508b at the second end 556 of the carton 505. Similarly, the first end panel 530c, the first side end flaps 534c, 542c, and the first side tabs 536c, 544c close a first end 550c of the third tray section 508c at the first end 552 of the carton 505, and the second end panel 532c, the second side end flaps 538c, 546c, and the second side tabs 540c, 548c close a second end 554c of the third tray section 508c at the second end 556 of the carton 505. In accordance with an alternative embodiment of the present disclosure, different flap arrangements can be used for at least partially closing the first and second ends 552, 556 of the carton 505.

The first end panels 530a, 530b, 530c, the first side end flaps 534a, 534b, 534c, 542a, 542b, 542c, and the first side tabs 536a, 536b, 536c, 544a, 544b, 544c extend along a first marginal area of the blank 503 and are foldably connected at a first longitudinal fold line 558 that extends along the length of the blank. The second end panels 532a, 532b, 532c, the second side end flaps 538a, 538b, 538c, 546a, 546b, 546c, and the second side tabs 540a, 540b, 540c, 548a, 548b, 548c extend along a second marginal area of the blank 503 and are foldably connected at a second longitudinal fold line 560 that also extends along the length of the blank. The longitudinal fold lines 558, 560 may be, for example, substantially straight or offset at one or more locations to account for blank thickness or for other factors.

As shown in FIG. 9, each of the first and second end panels 530a, 530b, 530c, 532a, 532b, 532c includes two curved edges 562 extending from the respective longitudinal fold line 558, 560. Further, the end panels 530a, 530b, 532a, 532b can each include an extension flap 564 connected to the respective end panel along a transverse score 566. For example, as illustrated in FIG. 9, the first and second end panels 530c, 532c of the third tray portion 507c lack extension flaps 564, and the extension flaps 564 connected to the first and second end panels 530a, 532a, 530b, 532b of the respective first and second tray portions 507a, 507b are for overlapping the respective first and second end panels 530c, 532c (FIG. 10).

The blank 503 could be otherwise shaped, arranged, and/or configured without departing from the disclosure. For example, the first and second end panels 530a, 530b, 532a, 532b of the first and second tray portions 507a, 507b could lack extension panels 564, and each of the first and second end panels 530c, 532c of the third tray portion 507c could include extension flaps 564 for overlapping the first and second end panels 530a, 530b, 532a, 532b. Additionally, the blank can include any suitable number of tray portions for forming a corresponding number of tray sections when formed into the carton.

As shown in FIG. 10, the carton 505 can be assembled by initially folding the first end panels 530a, 530b, 530c and the first side end flaps 534a, 534b, 534c, 542a, 542b, 542c along the longitudinal fold line 558 so that the first end panels and the first side end flaps extend generally vertically from the interior surface 568 of the blank, and folding the second end panels 532a, 532b, 532c and the second side end flaps 538a, 538b, 538c, 546a, 546b, 546c along the longitudinal fold line 560 so that the second end panels and second side end flaps extend generally vertically from the interior surface 568. The side panels 522a, 526a, 522b, 526b, 522c, 526c can be folded upwardly with respect to the respective bottom panels 520a, 520b, 520c so that the lower portion of each side panel engages and curves along the respectively adjacent curved edge 562 of the respective end panels 530a, 532a, 530b, 532b, 530c, 532c. While the side panels 526a, 522c are folded upwardly, they can be folded along the interconnecting fold line 509 so that the interconnecting fold line connects the tray section 508a to the tray section 508c and the second side panel 526a is adjacent and/or at least partially in face-to-face contact with the first side panel 522c. Similarly, while the side panels 522b, 526c are folded upwardly, they can be folded along the interconnecting fold line 511 so that the interconnecting fold line connects the tray section 508b to the tray section 508c and the first side panel 522b is adjacent and/or at least partially in face-to-face contact with the second side panel 526c. The ledge flaps 513a, 513b can be folded along the transverse fold lines 515a, 515b to form generally horizontal rims extending along the sides of the carton 505.

In the illustrated embodiment, the ends 550a, 550b, 550c of the respective tray sections 508a, 508b, 508c at the first end 552 of the carton 505 can be closed by securing the first side panels 522a, 522b, 522c to the respective end panels 530a, 530b, 530c by gluing the first side end flaps 534a, 534b, 534c to the interior surface of the respective end panel 530a, 530b, 530c and gluing the first side end tab 536a, 536b, 536c to the exterior surface of the respective end panel 530a, 530b, 530c. The second side panels 526a, 526b, 526c can be secured to the respective end panels 530a, 530b, 530c by gluing the first side end flaps 542a, 542b, 542c to the interior surface of the respective end panel 530a, 530b, 530c and gluing the first side end tab 544a, 544b, 544c to the exterior surface of the respective end panel 530a, 530b, 530c. The ends 554a, 554b, 554c of the respective tray sections 508a, 508b, 508c at the second end 556 of the carton 505 can be closed in substantially the same way as the first end 552 by gluing the second side end flaps 538a, 546a, 538b, 546b, 538c, 546c to the interior surface of the respective end panel 532a, 532b, 532c and gluing the second side end tabs 540a, 548a, 540b, 548b, 540c, 548c to the exterior surface of the respective end panel 532a, 532b, 532c. The ends 550a, 554a, 550b, 554b, 550c, 554c of the respective tray sections 508a, 508b, 508c can be alternatively closed without departing from the scope of the disclosure.

As shown in FIG. 10, the extension flaps 564 of the end panels 530a, 530b can be glued in face-to-face contact with the exterior surface of the end panel 530c, and the extension flaps 564 of the end panels 532a, 532b can be glued in face-to-face contact with the exterior surface of the end panel 532c to help keep the tray sections 508a, 508b from folding relative to the tray section 508c along the respective interconnecting fold lines 509, 511.

In the illustrated embodiment, articles (not shown), such as food products, can be loaded into each of the interiors 510a, 510b, 510c of the respective tray sections 508a, 508b, 508c of the erected carton 505. Alternative assembling, loading, and closing steps may be used without departing from the scope of the disclosure. Further, in one exemplary embodiment, the carton 505 can be inserted into an outer carton or bag (not shown) or wrapped in a plastic liner (not shown).

The number of tray portions 507a, 507b, 507c and tray sections 508a, 508b, 508c of the blank 503 and the carton 505 are shown and described with reference to the fifth embodiment by way of example. Alternatively, the blank 503 and the carton 505 can include any suitable number of tray portions and tray sections without departing from the scope of the disclosure.

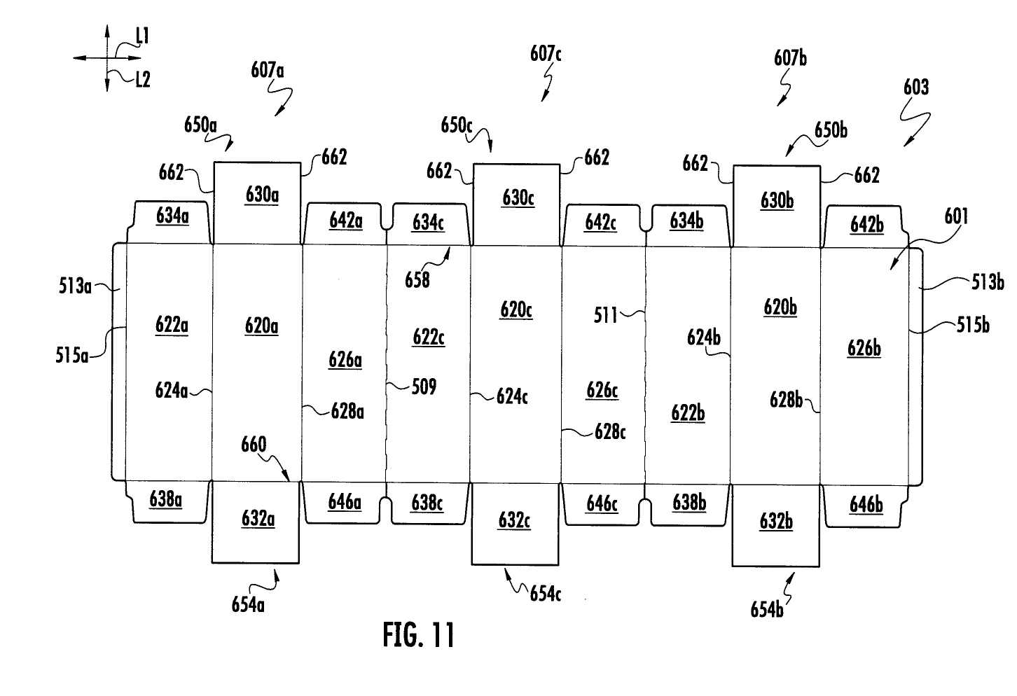

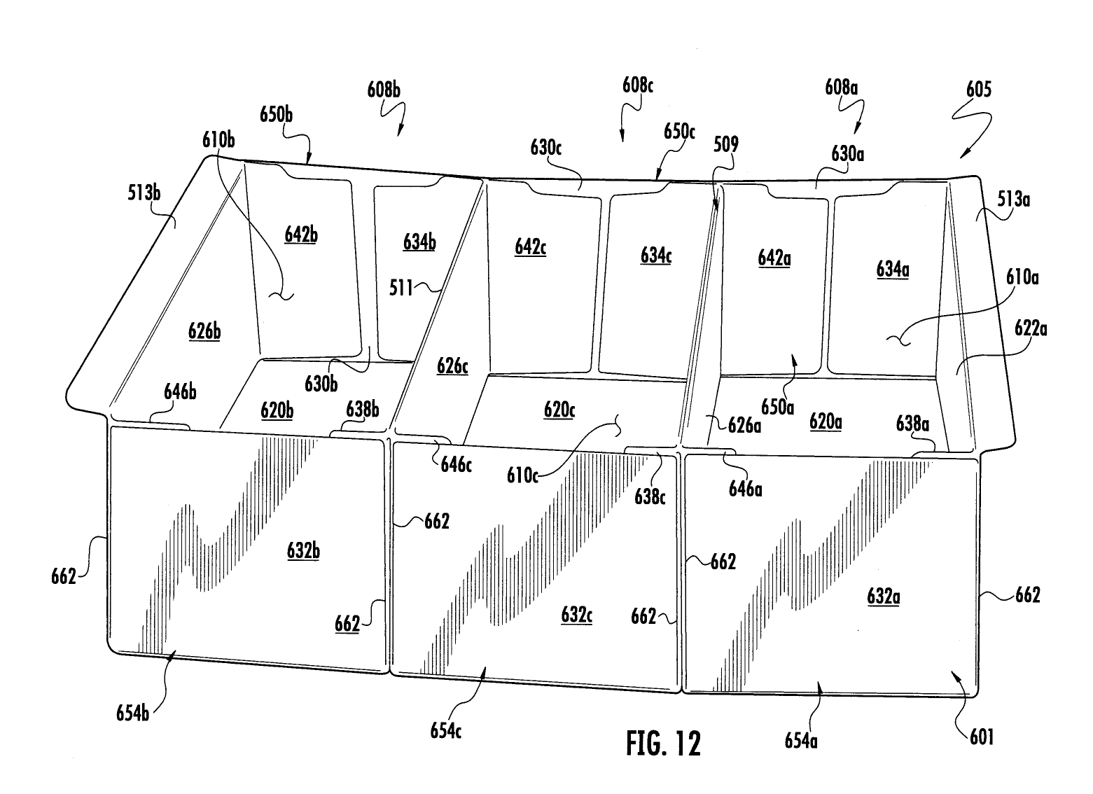

FIG. 11 is a plan view of an exterior surface 601 of a blank 603 for forming a carton tray 605 (FIG. 12) according to a sixth embodiment of the disclosure. The sixth embodiment is generally similar to the fifth embodiment, except for variations noted and variations that will be apparent to one of ordinary skill in the art. Accordingly, similar or identical features of the fifth and sixth embodiments have been given like or similar reference numbers. As shown in FIG. 11, the blank 603 includes tray portions 607a, 607b, 607c for forming respective tray section 608a, 608b, 608c with respective tray interiors 610a, 610b, 610c in the carton 605.

As shown in FIG. 11, the tray portions 607a, 607b, 607c include respective bottom panels 620a, 620b, 620c, respective first side panels 622a, 622b, 622c connected to the respective bottom panels along respective transverse fold lines 624a, 624b, 624c, and respective second side panels 626a, 626b, 626c connected to the respective bottom panels along respective transverse fold lines 628a, 628b, 628c. First end panels 630a, 630b, 630c are foldably connected to the respective bottom panels 620a, 620b, 620c along a longitudinal fold line 658, and second end panels 632a, 632b, 632c are foldably connected to the respective bottom panels 620a, 620b, 620c along a longitudinal fold line 660. Each of the first and second end panels 630a, 632a, 630b, 632b, 630c, 632c is generally rectangular (e.g., square) with two free edges 662 that can be generally collinear with the respective transverse fold lines 624a, 628a, 624b, 628b, 624c, 628c. Additionally, the first side end flaps 634a, 634b, 634c and 642a, 642b, 642c can be connected to the respective first and second side panels 622a, 622b, 622c and 626a, 626b, 626c along the longitudinal fold line 658, and the second side end flaps 638a, 638b, 638c and 646a, 646b, 646c can be connected to the respective first and second side panels 622a, 622b, 622c and 626a, 626b, 626c along longitudinal fold line 660. The blank 603 could be otherwise shaped, arranged, and/or configured without departing from the disclosure.

In the illustrated embodiment, the carton tray 605 can be erected in a similar manner as the carton tray 505 of the fifth embodiment. As shown in FIG. 12, the side panels 622a, 626a, 622b, 626b, 622c, 626c and the end panels 630a, 632a, 630b, 632b, 630c, 632c are folded to extend generally vertically from the respective bottom panels 620a, 620b, 620c. The first side end flaps 634a, 642a, 634b, 642b, 634c, 642c can be glued in face-to-face contact with the respective first end panels 630a, 630b, 630c to close the respective first ends 650a, 650b, 650c of the respective tray sections 608a, 608b, 608c, and the second side end flaps 638a, 646a, 638b, 646b, 638c, 646c can be glued in face-to-face contact with the respective second end panels 632a, 632b, 632c to close the respective second ends 654a, 654b, 654c of the respective tray sections 608a, 608b, 608c. Accordingly, each of the tray sections 608a, 608b, 608c encloses a respective interior 610a, 610b, 610c.

In the illustrated embodiment, the third tray section 608c can be secured to the first and second sections 608a, 608b to prevent the tray sections from pivoting with respect to one another. For example, the first side panel 622c of the third tray section 608c can be at least partially glued in face-to-face contact with the second side panel 626a of the first tray section 608a, and the second side panel 626c of the third tray section 608c can be at least partially glued in face-to-face contact with the first side panel 622b of the second tray section 608b. Alternatively, the carton 605 can include one or more extension flaps (not shown) similar to the extension flaps 564 of the fifth embodiment for attaching the end panels of one or more of the tray sections to adjacent end panels.

As shown in FIG. 12, the side panels 622a, 626a, 622b, 626b, 622c, 626c are generally aligned with the respective free edges 662 of the respective end panels 630a, 632a, 630b, 632b, 630c, 632c. Accordingly, each of the tray sections 608a, 608b, 608c has a generally rectangular cross-section. Alternative assembling, loading, and closing steps may be used without departing from the scope of the disclosure.

The number of tray portions 607a, 607b, 607c and tray sections 608a, 608b, 608c of the blank 603 and the carton 605 are shown and described with reference to the sixth embodiment by way of example. Alternatively, the blank 603 and the carton 605 can include any suitable number of tray portions and tray sections without departing from the scope of the disclosure.

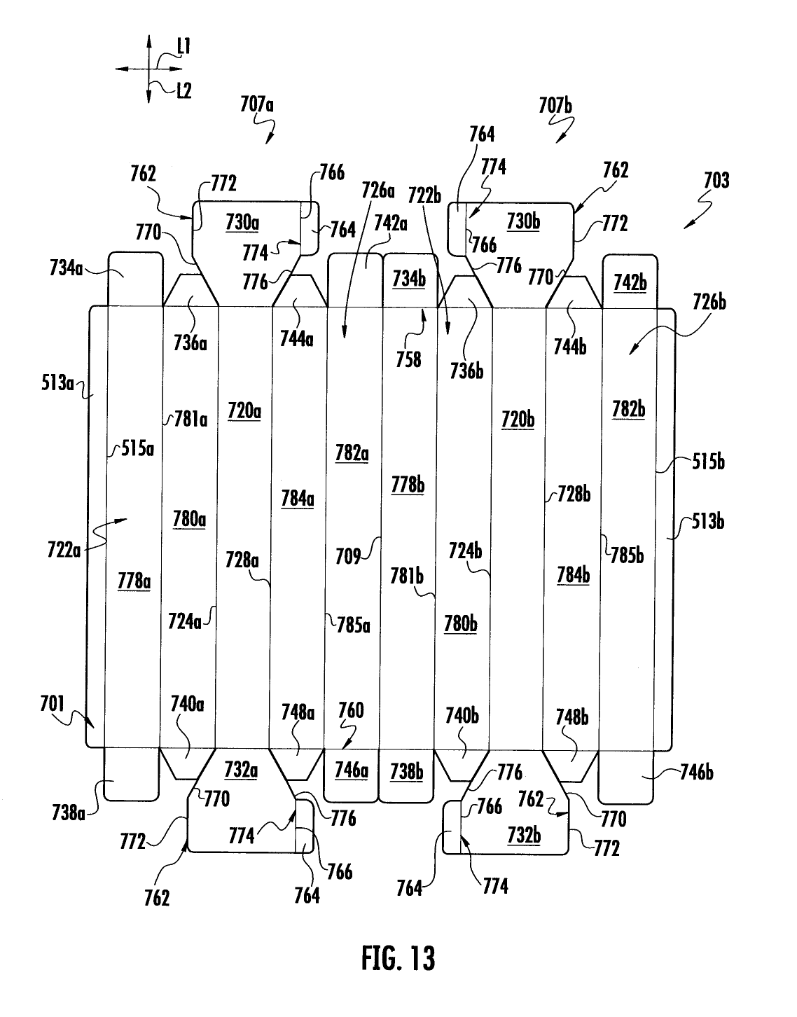

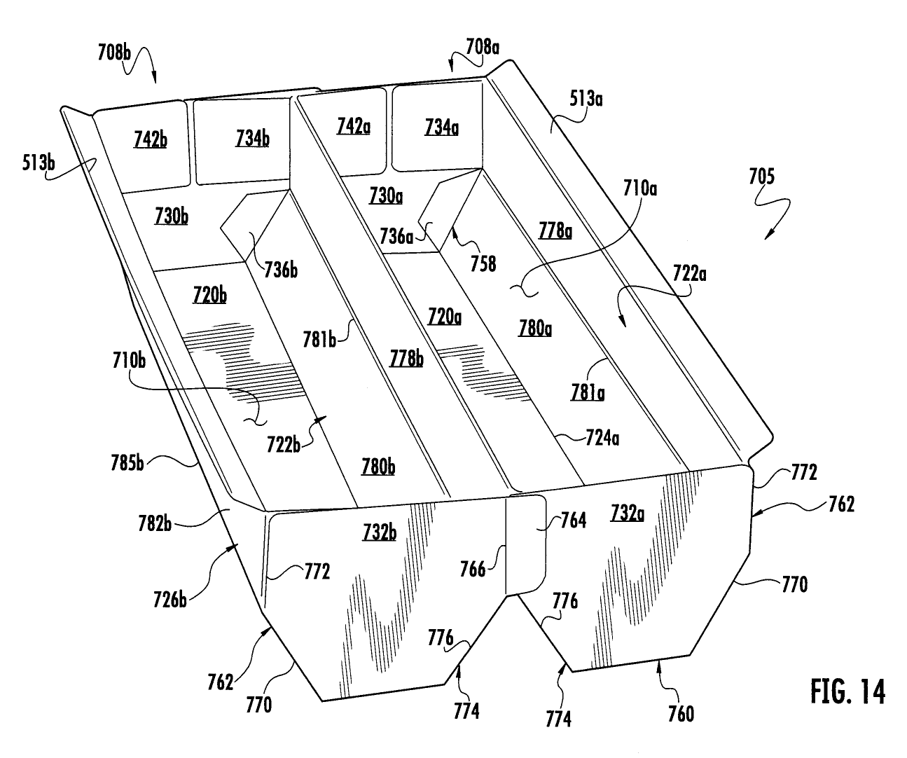

FIG. 13 is a plan view of an exterior surface 701 of a blank 703 for forming a carton tray 705 (FIG. 14) according to a seventh embodiment of the disclosure. The seventh embodiment is generally similar to the fifth and sixth embodiments, except for variations noted and variations that will be apparent to one of ordinary skill in the art. Accordingly, similar or identical features of the fifth, sixth, and seventh embodiments have been given like or similar reference numbers. As illustrated in FIG. 13, the L1 direction will be referred to as the longitudinal direction and the L2 direction will be referred to as the transverse or lateral direction in the seventh embodiment of the blank 703 in order to comport with the convention established for blanks 503 and 603 of the respective fifth and sixth embodiments (FIGS. 9 and 11). As shown in FIG. 13, the blank 703 includes two tray portions 707a, 707b foldably connected along a transverse interconnecting fold line 709 for forming respective tray section 708a, 708b with respective tray interiors 710a, 710b in the carton 705 (FIG. 14).

As shown in FIG. 13, the tray portions 707a, 707b include respective bottom panels 720a, 720b, respective first side panels 722a, 722b connected to the respective bottom panels along respective transverse fold lines 724a, 724b, and respective second side panels 726a, 726b connected to the respective bottom panels along respective transverse fold lines 728a, 728b. First end panels 730a, 730b are foldably connected to the respective bottom panels 720a, 720b along a longitudinal fold line 758, and second end panels 732a, 732b are foldably connected to the respective bottom panels 720a, 720b along a longitudinal fold line 760.

In the illustrated embodiment, each of the first and second end panels 730a, 732a, 730b, 732b can include an outer edge 762 with a lower segment 770 extending obliquely from the respective longitudinal fold line 758, 760 to an upper segment 772, which can extend generally in the transverse direction L2. Each of the first and second end panels 730a, 732a, 730b, 732b can also include an inner edge 774 with a lower segment 776 extending obliquely from the respective longitudinal fold line 758, 760 to an upper segment corresponding to the score 766 connecting the extension flaps 764, which scores 766 can extend generally in the transverse direction L2. Alternatively, one or more of the extension flaps 764 can be omitted (e.g., the extension flaps of the first and second end panels 730b, 732b of the second tray portion 707b can be omitted) so that the upper segments of the respective inner edges 774 are free edges.

As shown in FIG. 13, each of the first side panels 722a, 722b can include a first upper section 778a, 778b foldably connected to a first lower section 780a, 780b along a respective transverse fold line 781a, 781b, and each of the second side panels 726a, 726b can include a second upper section 782a, 782b foldably connected to a second lower section 784a, 784b along a respective transverse fold line 785a, 785b. First upper side end flaps 734a, 734b and second upper side end flaps 738a, 738b are foldably connected to the respective first upper sections 778a, 778b along the respective longitudinal fold lines 758, 760, and first upper side end flaps 742a, 742b and second upper side end flaps 746a, 746b are foldably connected to the respective second upper sections 782a, 782b along the respective longitudinal fold lines 758, 760. Similarly, first lower side end flaps 736a, 736b and second lower side end flaps 740a, 740b are foldably connected to the respective first lower sections 780a, 780b along the respective longitudinal fold lines 758, 760, and first lower side end flaps 744a, 744b and second upper side end flaps 748a, 748b are foldably connected to the respective second lower sections 784a, 784b along the respective longitudinal fold lines 758, 760. The blank 703 could be otherwise shaped, arranged, and/or configured without departing from the disclosure.

In the illustrated embodiment, the carton tray 705 can be erected in a similar manner as the carton tray 505 of the fifth embodiment. As shown in FIG. 14, the end panels 730a, 730b, 732a, 732b are folded upwardly along the respective longitudinal fold lines 758, 760. The first lower sections 780a, 780b and the second lower sections 784a, 784b are folded along the respective fold lines 724a, 724b, 728a, 728b so that the first lower section 780a and the second lower section 784b are generally aligned with the respective lower segment 770 of the outer edges 762 of the end panels and the second lower section 784a and the first lower section 780b are generally aligned with a respective lower segment 776 of the inner edges 774 of the end panels. The lower sections 780a, 780b, 784a, 784b can extend in an oblique direction (FIG. 14). The first lower side end flaps 736a, 744a and 736b, 744b can be glued in face-to-face contact with the respective first end panel 730a, 730b, and the second lower side end flaps 740a, 748a, 740b, 748b can be glued in face-to-face contact with the respective second end panel 732a, 732b.

The first upper sections 778a, 778b and the second upper sections 782a, 782b can be folded along the respective transverse fold lines 781a, 781b, 785a, 785b so that the first upper section 778a and the second upper section 782b are generally vertical and aligned with the respective upper segments 772 of the outer edges 762 of the end panels and the second upper section 782a and the first upper section 778b are generally aligned with the respective upper segment of the inner edge 774 of the end panels, which upper segments correspond to the scores 766 connecting the extension flaps 764 to the end panels. The first upper side end flaps 734a, 742a and 734b, 742b can be glued in face-to-face contact with the respective first end panel 730a, 730b, and the second upper side end flaps 738a, 746a, 738b, 746b can be glued in face-to-face contact with the respective second end panel 732a, 732b. Accordingly, each of the tray sections 708a, 708b encloses a respective interior 710a, 710b. The extension flaps 764 at each end can be overlapped and glued in face-to-face contact with an adjacent end panel to secure the first tray section 708a to the second tray section 708b.

The number of tray portions 707a, 707b and tray sections 708a, 708b of the blank 703 and the carton 705 are shown and described with reference to the sixth embodiment by way of example. Alternatively, the blank 703 and the carton 705 can include any suitable number of tray portions and tray sections without departing from the scope of the disclosure.

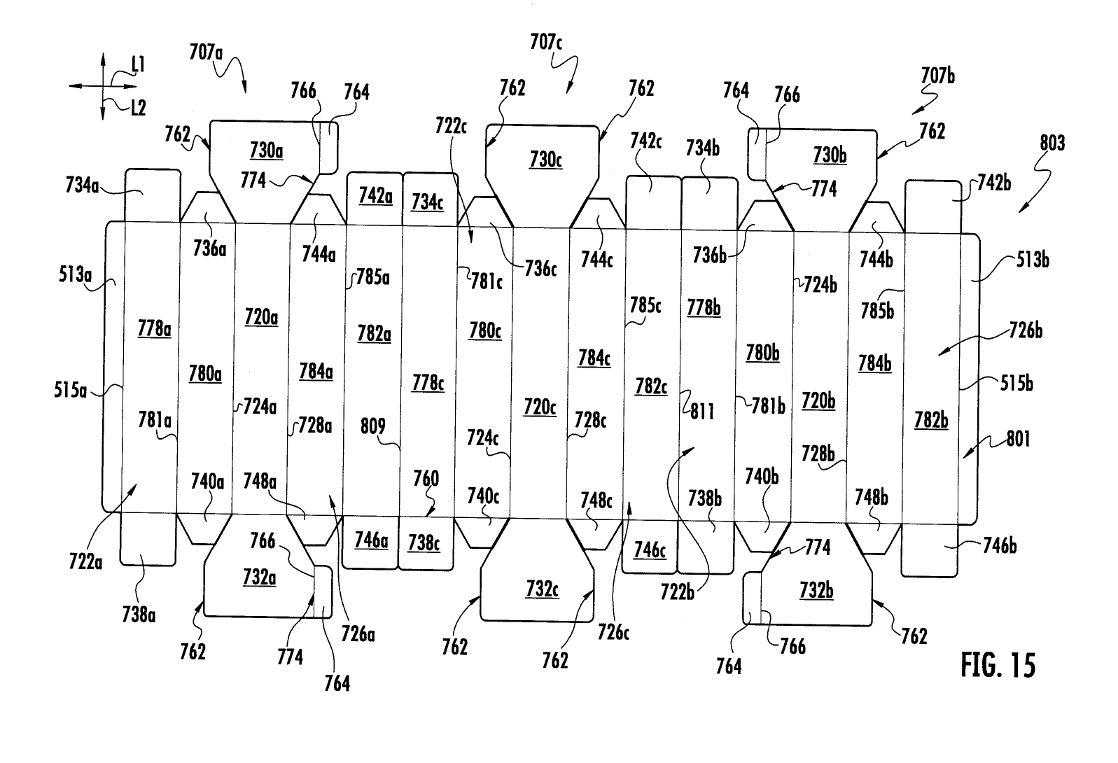

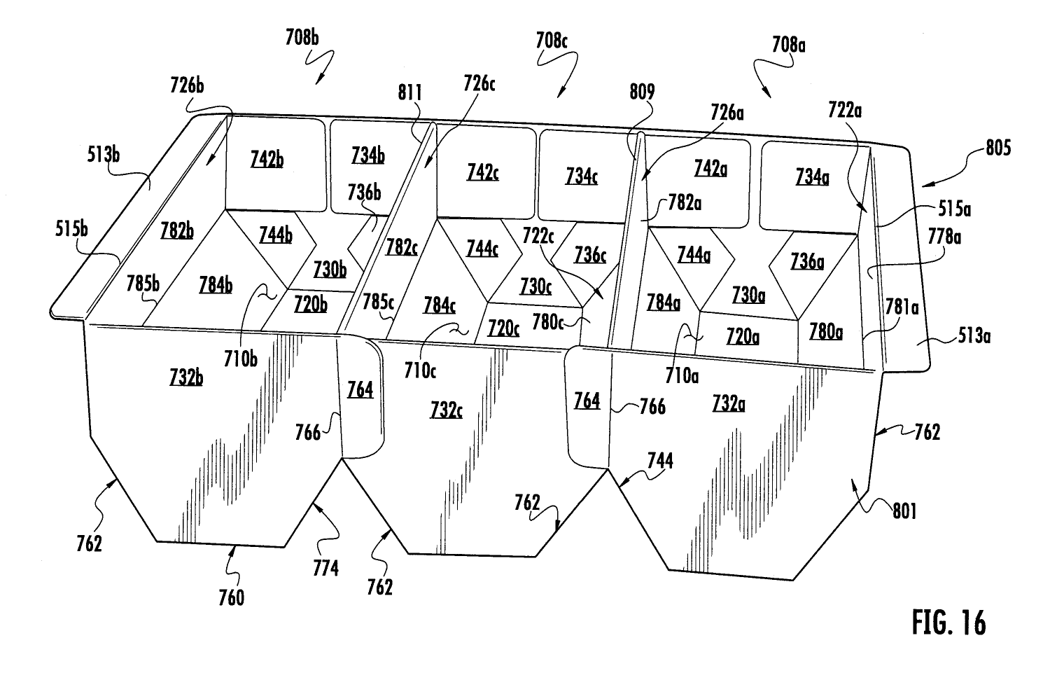

For example, FIG. 15 is a plan view of an exterior surface 801 of a blank 803 for forming a carton tray 805 (FIG. 16) according to an eighth embodiment of the disclosure. The eighth embodiment is generally similar to the seventh embodiment, except for variations noted and variations that will be apparent to one of ordinary skill in the art. Accordingly, similar or identical features of the seventh and eighth embodiments have been given like or similar reference numbers. As shown in FIG. 15, the blank 803 includes a third tray portion 707c disposed between the first and second tray portions 707a, 707b. The third tray portion 707c is foldably connected to the first tray portion 707a along a transverse interconnecting fold line 809 and the second tray portion 707b along a transverse interconnecting fold line 811. As shown in FIG. 16, the third tray portion 707c forms a tray section 708c with a tray interior 710c in the carton 805. Features of the tray portion 707c and the tray section 708c that are similar or identical to corresponding features in the first and second tray portions 707a, 707b and sections 708a, 708b have similar reference numbers where the “a” or “b” is replaced with a “c.” The blank 803 and the carton 805 could be otherwise shaped, arranged, and/or configured without departing from the disclosure.

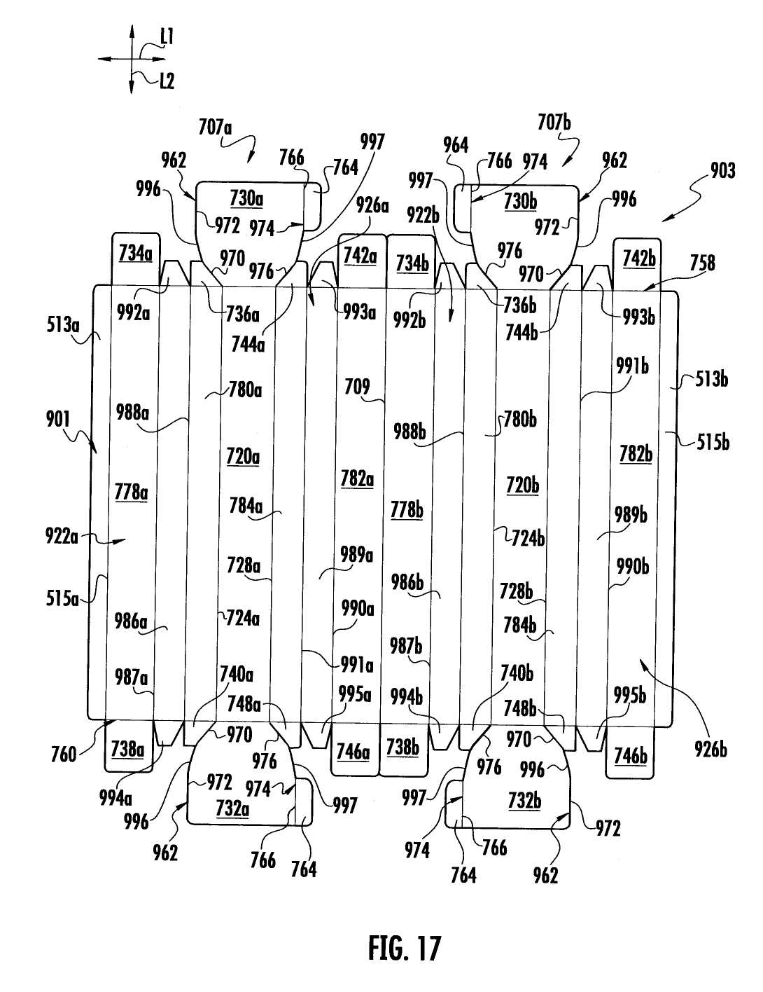

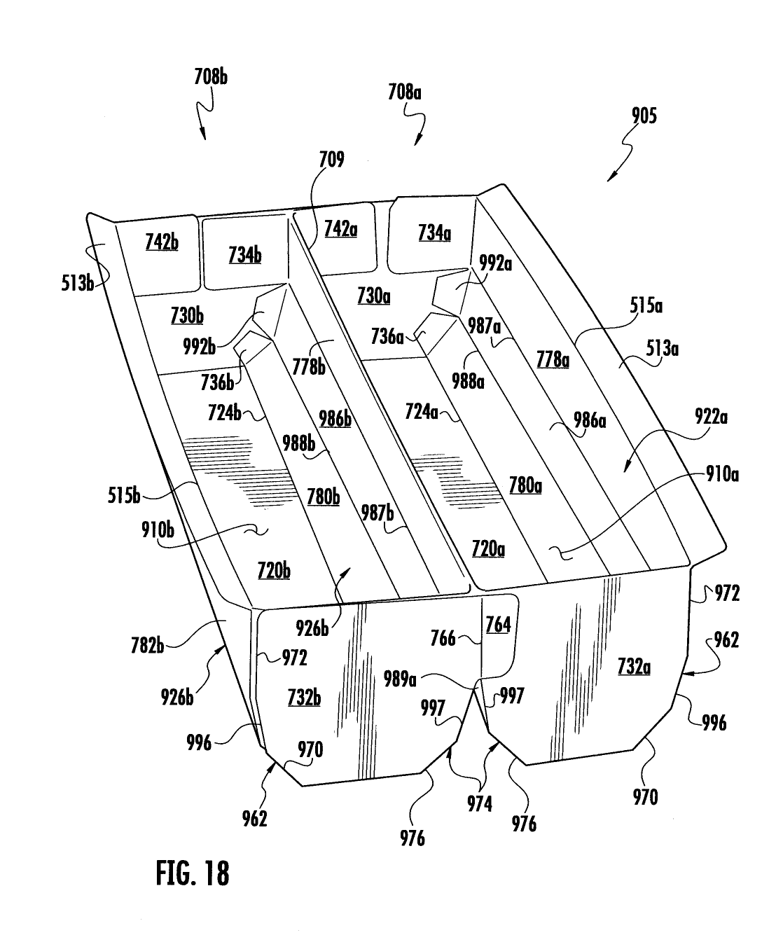

FIG. 17 is a plan view of an exterior surface 901 of a blank 903 for forming a carton tray 905 (FIG. 18) according to an ninth embodiment of the disclosure. The ninth embodiment is generally similar to the seventh embodiment, except for variations noted and variations that will be apparent to one of ordinary skill in the art. Accordingly, similar or identical features of the seventh and ninth embodiments have been given like or similar reference numbers. As illustrated in FIG. 17, the L1 direction will be referred to as the longitudinal direction and the L2 direction will be referred to as the transverse or lateral direction in the ninth embodiment of the blank 903 in order to comport with the convention established for blanks 503 and 603 of the respective fifth and sixth embodiments (FIGS. 9 and 11).

As shown in FIG. 17, the blank 903 includes two tray portions 907a, 907b for forming respective tray sections 908a, 908b in the carton 905. Each of the first side panels 922a, 922b of the blank 903 can include a respective first intermediate section 986a, 986b foldably connected to the respective upper sections 778a, 778b along transverse fold lines 987a, 987b and the respective lower sections 780a, 780b along transverse fold lines 988a, 988b. Similarly, each of the second side panels 926a, 926b of the blank 903 can include a respective second intermediate section 989a, 989b foldably connected to the respective upper sections 782a, 782b along transverse fold lines 990a, 990b and the respective lower sections 784a, 784b along transverse fold lines 991a, 991b. First intermediate side end flaps 992a, 992b, 993a, 993b are foldably connected to the respective first intermediate sections 986a, 986b and second intermediate sections 989a, 989b along the longitudinal fold line 758, and second side intermediate end flaps 994a, 994b, 995a, 995b are foldably connected to the respective first intermediate sections 986a, 986b and second intermediate sections 989a, 989b along the longitudinal fold line 760.

As shown in FIG. 17, the end panels 730a, 730b, 732a, 732b can include outer edges 962 with lower segments 970, intermediate segments 996, and upper segments 972, and inner edges 974 with lower segments 976, intermediate segments 997, and upper segments corresponding to the respective scores 766 connecting the respective extension flaps 764 to the respective end panels. Alternatively, one or more of the extension flaps 764 can be omitted, and the upper segments of the inner edges 974 can be free edges (not shown).

In the illustrated embodiment, when the blank 903 is formed into the carton 905 (FIG. 18), the first upper side end flaps 734a, 742a, the first intermediate side end flaps 992a, 993a, and the first lower side end flaps 736a, 744a are glued in face-to-face contact with the first end flap 730a so that the first upper sections 778a, 782a are generally aligned with the respective upper segment 972 of the outer edge 962 and score 766 of the inner edge 974, the first intermediate sections 986a, 989a are generally aligned with the respective intermediate segments 996, 997 of the respective outer edge 962 and inner edge 974, and the first lower sections 780a, 784a are generally aligned with the respective lower segments 970, 976 of the respective outer edge 962 and inner edge 974. Similarly, the second upper side end flaps 738a, 746a, the first intermediate side end flaps 994a, 995a, and the first lower side end flaps 740a, 748a are glued in face-to-face contact with the second end flap 732a so that the first upper sections 778a, 782a are generally aligned with the respective upper segment 972 of the outer edge 962 and score 766 of the inner edge 974, the first intermediate sections 986a, 989a are generally aligned with the respective intermediate segments 996, 997 of the respective outer edge 962 and inner edge 974, and the first lower sections 780a, 784a are generally aligned with the respective lower segments 970, 976 of the respective outer edge 962 and inner edge 974. Accordingly, the first tray section 908a defines an interior 910a wherein the upper sections 778a, 782a of the respective first and second side panels 922a, 926a extend generally vertically, the lower sections 780a, 784a extend in an oblique direction relative to the bottom panel 720a, and the intermediate sections 986a, 989a extend in a direction that is oblique relative to both the upper and lower sections.

As shown in FIG. 18, the second tray section 908b can be erected from the second tray portion 907b to define an interior 910b in a similar manner as the first tray section 908a is formed, as described above. Accordingly, the sections 778b, 986b, 780b of the first side panel 922b are generally aligned with the respective segments 766, 997, 976 of the inner edges 974 of the first and second end panels 730b, 732b, and the sections 782b, 989b, 784b of the second side panel 926b are generally aligned with the respective segments 972, 996, 970 of the outer edges 962 of the first and second end panels 730b, 732b. The blank 903 and the carton 905 could be otherwise shaped, arranged, and/or configured without departing from the disclosure.

The number of tray portions 907a, 907b and tray sections 908a, 908b of the blank 703 and the carton 705 are shown and described with reference to the sixth embodiment by way of example. Alternatively, the blank 903 and the carton 905 can include any suitable number of tray portions and tray sections without departing from the scope of the disclosure.

The flaps and panels detailed herein generally are secured to form a package, or carton. It is understood that forming the carton, packing the carton, and/or loading the carton and methods that differ than the forming, packing, and/or loading configurations discussed herein are within the scope of the disclosure.

In general, the blank may be constructed from paperboard having a caliper so that it is heavier and more rigid than ordinary paper. The blank can also be constructed of other materials, such as cardboard, or any other material having properties suitable for enabling the carton to function at least generally as described above.

The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

The above embodiments may be described as having one or panels adhered together by glue. The term “glue” is intended to encompass all manner of adhesives commonly used to secure paperboard or carton panels in place, and the adhesive material can be replaced by, or supplemented with any suitable fastening devices.

The term “line” as used herein includes not only straight lines, but also other types of lines such as curved, curvilinear or angularly displaced lines. In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, cut line, or the like. For example, a cut line can be a continuous slit or could be wider than a slit without departing from the present disclosure.

Any dimensions shown in the figures are exemplary only and can be expanded or contracted, such as to accommodate items of different sizes, configurations, or dimensions. These dimensions should not be construed as limiting in any manner.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments that are within the scope of the claims. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton comprising at least one tray section for holding a plurality of products, the at least one tray section comprising:
a plurality of panels at least partially extending around an interior of the at least one tray section, the plurality of panels comprising a bottom panel, a first side panel foldably connected to the bottom panel, a second side panel foldably connected to the bottom panel, and at least one end panel foldably connected to the bottom panel;
a first side end flap foldably connected to the first side panel along a longitudinal fold line and a second side end flap foldably connected to the second side panel along the longitudinal fold line, each of the first and second side end flaps at least partially overlapping the at least one end panel;
wherein the at least one end panel comprises a first end panel edge and an opposing second end panel edge, the first side panel comprises a first side panel edge that is generally aligned with the first end panel edge along the length of the first end panel edge, and the second side panel comprises a second side panel edge that is generally aligned with the second end panel edge along the length of the second end panel edge.

2. The carton of claim 1, wherein the at least one tray section comprises a plurality of tray sections, the plurality of tray sections comprising at least a first tray section and a second tray section, the first side panel of the first tray section being foldably connected to the second side panel of the second tray section along an interconnecting fold line.

3. The carton of claim 2, wherein the at least one end panel of at least one tray section of the plurality of tray sections comprises an extension flap that at least partially overlaps the at least one end panel of a respectively adjacent tray section of the plurality of tray sections.

4. The carton of claim 2, wherein at least one of the second side panel of the first tray section and the first side panel of the second tray section is foldably connected to a ledge flap.

5. The carton of claim 2, wherein, for each tray section of the plurality of tray sections, at least a portion of each of the first and second end panel edges is curved, and at least a portion of each of the first and second side panels is curved.

6. The carton of claim 5, wherein:
each tray section of the plurality of tray sections comprises a first side end tab foldably connected to the first side panel along the longitudinal fold line and a second side end tab foldably connected to the second side panel along the longitudinal fold line; and
each of the first and second side end tabs are in face-to-face contact with an exterior surface of the at least one end panel.

7. The carton of claim 2, wherein, for each tray section of the plurality of tray sections:
the first side panel comprises at least a first upper section and a first lower section;
the second side panel comprises at least a second upper section and a second lower section; and
the first and second lower sections extend in an oblique direction relative to the respective first and second upper section.

8. The carton of claim 7, wherein, for each tray section of the plurality of tray sections, the first and second upper sections extend generally vertically.

9. The carton of claim 7, wherein, for each tray section of the plurality of tray sections, the first and second lower sections are foldably connected to the respective first and second upper sections along a respective first transverse fold line and second transverse fold line.

10. The carton of claim 9, wherein:
for each tray section of the plurality of tray sections, the first side end flap is foldably connected to the first upper section, and the second side end flap is foldably connected to the second upper section;
each tray section of the plurality of tray sections comprises a third side end flap foldably connected to the first lower section along the longitudinal fold line and a fourth side end flap foldably connected to the second lower section along the longitudinal fold line; and
for each tray section of the plurality of tray sections, each of the third and fourth side end flaps at least partially overlaps the at least one end panel.

11. The carton of claim 7, wherein, for each tray section of the plurality of tray sections:
the first side panel further comprises a first intermediate section foldably connected to the first upper section and the first lower section;
the second side panel further comprises a second intermediate section foldably connected to the second upper section and the second lower section;
the first and second intermediate sections extending in an oblique direction relative to the respective first and second upper section and the respective first and second lower section.

12. The carton of claim 11, wherein:
for each tray section of the plurality of tray sections, the first side end flap is foldably connected to the first upper section, and the second side end flap is foldably connected to the second upper section;
each tray section of the plurality of tray sections comprises a third side end flap foldably connected to the first lower section along the longitudinal fold line, a fourth side end flap foldably connected to the second lower section along the longitudinal fold line, a fifth side end flap foldably connected to the first intermediate section along the longitudinal fold line, and a sixth side end flap foldably connected to the second intermediate section along the longitudinal fold line; and
for each tray section of the plurality of tray sections, each of the third, fourth, fifth, and sixth side end flaps at least partially overlaps the at least one end panel.

13. The carton of claim 2, wherein the plurality of tray sections further comprises at least a third tray section, the first side panel of the third tray section being foldably connected to the second side panel of the first tray section along a second interconnecting fold line.

14. A blank comprising at least one tray portion for forming at least one tray section of a carton, the at least one tray portion comprising:
a plurality of panels comprising a bottom panel, a first side panel foldably connected to the bottom panel, a second side panel foldably connected to the bottom panel, and at least one end panel foldably connected to the bottom panel;
a first side end flap foldably connected to the first side panel along a longitudinal fold line and a second side end flap foldably connected to the second side panel along the longitudinal fold line, each of the first and second side end flaps are for at least partially overlapping the at least one end panel;
wherein the at least one end panel comprises a first end panel edge and an opposing second end panel edge, the first side panel comprises a first side panel edge for being generally aligned with the first end panel edge along the length of the first end panel edge in the carton formed from the blank, and the second side panel comprises a second side panel edge for being generally aligned with the second end panel edge along the length of the second end panel edge in the carton formed from the blank.

15. The blank of claim 14, wherein the at least one tray portion comprises a plurality of tray portions, the plurality of tray portions comprising at least a first tray portion and a second tray portion, the first side panel of the first tray portion being foldably connected to the second side panel of the second tray portion along an interconnecting fold line.

16. The blank of claim 15, wherein the at least one end panel of at least one tray portion of the plurality of tray portions comprises an extension flap that is for at least partially overlapping the at least one end panel of a respectively adjacent tray portion of the plurality of tray portions in the carton formed from the blank.

17. The blank of claim 15, wherein at least one of the second side panel of the first tray portion and the first side panel of the second tray portion is foldably connected to a ledge flap.

18. The blank of claim 15, wherein, for each tray portion of the plurality of tray portions, at least a portion of each of the first and second end panel edges is curved, and at least a portion of each of the first and second side panels is for being curved in the carton formed from the blank.

19. The blank of claim 18, wherein:
each tray portion of the plurality of tray portions comprises a first side end tab foldably connected to the first side panel along the longitudinal fold line and a second side end tab foldably connected to the second side panel along the longitudinal fold line; and
each of the first and second side end tabs are for being in face-to-face contact with an exterior surface of the at least one end panel in the carton formed from the blank.

20. The blank of claim 15, wherein, for each tray portion of the plurality of tray portions:
the first side panel comprises at least a first upper section and a first lower section;
the second side panel comprises at least a second upper section and a second lower section; and
the first and second lower sections are for extending in an oblique direction relative to the respective first and second upper section in the carton formed from the blank.

21. The blank of claim 20, wherein, for each tray portion of the plurality of tray portions, the first and second upper sections are for extending generally vertically in the carton formed from the blank.

22. The blank of claim 20, wherein, for each tray portion of the plurality of tray portions, the first and second lower sections are foldably connected to the respective first and second upper sections along a respective first transverse fold line and second transverse fold line.

23. The blank of claim 22, wherein:
for each tray portion of the plurality of tray portions, the first side end flap is foldably connected to the first upper section, and the second side end flap is foldably connected to the second upper section;
each tray portion of the plurality of tray portions comprises a third side end flap foldably connected to the first lower section along the longitudinal fold line and a fourth side end flap foldably connected to the second lower section along the longitudinal fold line; and
for each tray portion of the plurality of tray portions, each of the third and fourth side end flaps is for at least partially overlapping the at least one end panel in the carton formed from the blank.

24. The blank of claim 20, wherein, for each tray portion of the plurality of tray portions:
the first side panel further comprises a first intermediate section foldably connected to the first upper section and the first lower section;
the second side panel further comprises a second intermediate section foldably connected to the second upper section and the second lower section;
the first and second intermediate sections are for extending in an oblique direction relative to the respective first and second upper section and the respective first and second lower section in the carton formed from the blank.

25. The blank of claim 24, wherein:
for each tray portion of the plurality of tray portions, the first side end flap is foldably connected to the first upper section, and the second side end flap is foldably connected to the second upper section;
each tray portion of the plurality of tray portions comprises a third side end flap foldably connected to the first lower section along the longitudinal fold line, a fourth side end flap foldably connected to the second lower section along the longitudinal fold line, a fifth side end flap foldably connected to the first intermediate section along the longitudinal fold line, and a sixth side end flap foldably connected to the second intermediate section along the longitudinal fold line; and
for each tray portion of the plurality of tray portions, each of the third, fourth, fifth, and sixth side end flaps is for at least partially overlapping the at least one end panel in the carton formed from the blank.

26. The blank of claim 15, wherein the plurality of tray portions further comprises at least a third tray portion, the first side panel of the third tray portion being foldably connected to the second side panel of the first tray portion along a second interconnecting fold line.

27. A method of forming a carton comprising at least one tray section, the method comprising:
obtaining a blank comprising at least one tray portion, the at least one tray portion comprising
a plurality of panels comprising a bottom panel, a first side panel foldably connected to the bottom panel, a second side panel foldably connected to the bottom panel, and at least one end panel foldably connected to the bottom panel;
a first side end flap foldably connected to the first side panel along a longitudinal fold line and a second side end flap foldably connected to the second side panel along the longitudinal fold line;
forming the at least one tray section having an interior from the at least one tray portion by folding the at least one end panel relative to the bottom panel and folding the first and second side panels relative to the bottom panel so that at least a portion of each of the first and second side panels is generally aligned with a respective first end panel edge and second end panel edge of the at least one end panel; and
overlapping at least a portion of each of the first and second side end flaps with at least a portion of the at least one end panel.

28. The method of claim 27, wherein:
the at least one tray portion comprises a plurality of tray portions, the plurality of tray portions comprising at least a first tray portion and a second tray portion, the first side panel of the first tray portion being foldably connected to the second side panel of the second tray portion along an interconnecting fold line; and
the forming the at least one tray section comprises forming a first tray section having a first interior from the first tray portion and forming a second tray section having a second interior from the second tray portion.

29. The method of claim 28, wherein:
for each tray portion of the plurality of tray portions, at least a portion of each of the first and second end panel edges is curved; and
for each of the first and second tray sections, the folding the first and second side panels relative to the bottom panel comprises curving at least a portion of each of the first and second side panels to conform to the first and second end panel edges.

30. The method of claim 28, wherein, for each tray portion of the plurality of tray portions:
the first side panel comprises at least a first upper section and a first lower section;
the second side panel comprises at least a second upper section and a second lower section; and
the folding the first and second side panels relative to the bottom panel comprises aligning the first and second lower sections in an oblique direction relative to the respective first and second upper section.

31. The method of claim 30, wherein:
for each tray portion of the plurality of tray portions, the first side end flap is foldably connected to the first upper section, and the second side end flap is foldably connected to the second upper section;
each tray portion of the plurality of tray portions comprises a third side end flap foldably connected to the first lower section along the longitudinal fold line and a fourth side end flap foldably connected to the second lower section along the longitudinal fold line; and
for each tray section of the plurality of tray sections, the method further comprises at least partially overlapping each of the third and fourth side end flaps with the at least one end panel.

32. The method of claim 30, wherein, for each tray portion of the plurality of tray portions:
the first side panel further comprises a first intermediate section foldably connected to the first upper section and the first lower section;
the second side panel further comprises a second intermediate section foldably connected to the second upper section and the second lower section; and
the folding the first and second side panels relative to the bottom panel further comprises aligning the first and second intermediate sections in an oblique direction relative to the respective first and second upper section and the respective first and second lower section.
